(19) United States
(12) Patent Application Publication
(10) Pub. No.: US 2026/0288291 A1
(43) Pub. Date: Sep. 24, 2026

(54) DISPLAY SYSTEM AND DISPLAY METHOD

(71) Applicant: Toyota Jidosha Kabushiki Kaisha, Toyota-shi (JP)

(72) Inventor: Kazuho SAEKI, Kawasaki-shi (JP)

(73) Assignee: Toyota Jidosha Kabushiki Kaisha, Toyota-shi (JP)

(21) Appl. No.: 19/416,072

(22) Filed: Dec. 11, 2025

(30) Foreign Application Priority Data
Mar. 24, 2025 (JP) 2025-048529

(51) Int. Cl. G06F 3/048; G06T 11/26

(52) U.S. Cl. CPC G06F 3/048; G06T 11/26

(57) ABSTRACT

A display system according to the present disclosure includes a data acquisition unit configured to acquire a plurality of pieces of analysis target data, a feature amount acquisition unit configured to acquire a feature amount of the analysis target data, a display form determination unit configured to determine, based on an order of magnitudes of the feature amounts, a display form of the plurality of pieces of analysis target data to be plotted on one graph, and a display controller configured to display the graph based on the display form.

### CROSS-REFERENCE TO RELATED APPLICATION

This application claims priority to Japanese Patent Application No. 2025-048529 filed on Mar. 24, 2025. The disclosure of the above-identified application, including the specification, drawings, and claims, is incorporated by reference herein in its entirety.

### BACKGROUND

### 1. Technical Field

The present disclosure relates to a display system and a display method.

### 2. Description of Related Art

Japanese Unexamined Patent Application Publication No. 2024-106786 (JP 2024-106786 A) discloses an information processing apparatus that executes principal component analysis on measurement data of a material. The information processing apparatus disclosed in JP 2024-106786 A executes the principal component analysis on a plurality of pieces of the measurement data to generate a principal component of the pieces of measurement data and a principal component score of the principal component.

The information processing apparatus disclosed in JP 2024-106786 A displays the principal component score of each of the generated pieces of measurement data on a display screen. In this case, each of images representing the principal component of the pieces of measurement data is displayed diagonally with respect to a horizontal direction or a vertical direction on the display screen.

In addition, the information processing apparatus disclosed in JP 2024-106786 A displays a graph in which the principal component score of the pieces of measurement data is plotted at a position representing an intersection of a line extending from a first image in the vertical direction and a line extending from a second image in the horizontal direction, for each of a pair of the first image and the second image among the images representing the principal component of the pieces of measurement data.

### SUMMARY

Extracting a feature amount represented by the principal component score from the data is one of the effective methods for executing an analysis of data. Here, appropriately understanding what feature of the data is represented by the extracted feature amount is important for a user in executing the analysis of the data.

However, in the related art, intuitively determining what feature of the data is represented by the extracted feature amount is difficult for the user. That is, in the related art, there is a problem that the feature amount cannot be easily interpreted.

The present disclosure has been made to solve such a problem, and an object thereof is to provide a display system and a display method that can facilitate interpretation of a feature amount.

A display system according to the present disclosure includes

a data acquisition unit configured to acquire a plurality of pieces of analysis target data,

a feature amount acquisition unit configured to acquire a feature amount of each of the pieces of analysis target data,

a display form determination unit configured to determine, based on an order of magnitudes of the feature amounts, a display form of the pieces of analysis target data to be plotted on one graph, and

a display controller configured to display the graph based on the display form.

The display form determination unit may determine a superimposition order of the analysis target data in the graph based on the order of the magnitudes of the feature amounts.

The display form determination unit may determine an offset amount of the analysis target data in the graph based on the order of the magnitudes of the feature amounts.

The feature amount may be a principal component score acquired by executing principal component analysis on the analysis target data, and

the display controller may display a principal component on the graph.

A display method according to the present disclosure includes

acquiring a plurality of pieces of analysis target data,

acquiring a feature amount of each of the pieces of analysis target data,

determining, based on an order of magnitudes of the feature amounts, a display form of the pieces of analysis target data to be plotted on one graph, and

displaying the graph based on the display form.

According to the present disclosure, it is possible to provide a display system and a display method that can facilitate interpretation of a feature amount.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram showing a configuration of an analysis system according to Embodiment 1;

FIG. 2 is a block diagram showing a hardware configuration of a server according to Embodiment 1;

FIG. 3 is a block diagram showing functions of the server according to Embodiment 1;

FIG. 4 is a schematic diagram showing an example of a configuration of a display screen in a case where a display form determination unit according to Embodiment 1 determines a superimposition order of analysis target data as a display form;

FIG. 5 is a schematic diagram showing an example of a configuration of the display screen in a case where the display form determination unit according to Embodiment 1 determines an offset amount of the analysis target data as the display form;

FIG. 6 is a schematic diagram showing another example of the configuration of the display screen in a case where the display form determination unit according to Embodiment 1 determines the superimposition order of the analysis target data as the display form; and

FIG. 7 is a flowchart showing a display method according to Embodiment 1.

### DETAILED DESCRIPTION OF EMBODIMENTS

Hereinafter, a specific embodiment of the present disclosure will be described in detail with reference to the drawings. However, the present disclosure is not limited to the following embodiment. In addition, in order to clarify the description, the following description and drawings are appropriately simplified.

### Embodiment 1

### Configuration of Display System

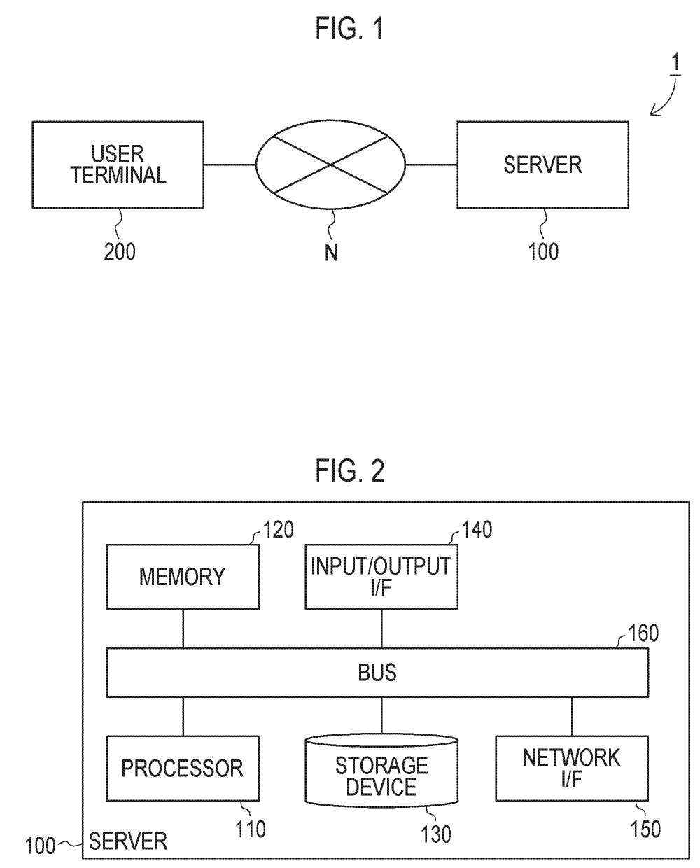

The display system according to Embodiment 1 is a system configured as a part of the analysis system according to Embodiment 1, and is a system for displaying an analysis result of the analysis system according to Embodiment 1 to a user. FIG. 1 is a block diagram showing a configuration of the analysis system according to Embodiment 1. As shown in FIG. 1, an analysis system 1 according to Embodiment 1 includes a server 100 and a user terminal 200. The server 100 and the user terminal 200 are connected to each other via a network N in a state where information can be transmitted. The network N includes a wireless circuit via a base station, such as the Internet, a local area network (LAN), and a wide area network (WAN). The network N may be wired or wireless as long as it is connected in a state where information can be transmitted.

The analysis system 1 is a system for analyzing the analysis target data. More specifically, the analysis system 1 is provided as a part of a data cloud type service used for material development or research and development. The analysis system 1 is used as a system for promoting so-called materials informatics (MI) or research and development using data science. In this case, the analysis system 1 stores various pieces of measurement data of a new development material, for example. Then, the analysis system 1 appropriately uses the stored measurement data as the analysis target data based on an instruction from the user.

In the analysis system 1, the user terminal 200 transmits the analysis target data to the server 100. Then, the server 100 analyzes the received analysis target data. After the analysis, the server 100 transmits the analysis result to the user terminal 200. Then, the user terminal 200 displays the received analysis result to present the analysis result to the user. The analysis target data is not particularly limited, and may be any data as long as it can be a target of the principal component analysis.

Examples of the analysis target data analyzed by the analysis system 1 include spectral data, waveform data, graph data, two-dimensional image data, and three-dimensional image data.

Examples of the spectral data include spectral data measured by using nuclear magnetic resonance spectroscopy (NMR), infrared spectroscopy (IR), ultraviolet-visible spectroscopy

(UV-vis), X-ray absorption spectroscopy (XAS), Raman spectroscopy, X-ray diffraction (XRD), small-angle X-ray scattering (SAXS), and mass spectrometry (MS).

In addition, examples of the two-dimensional image data include image data captured by using an optical microscope, a scanning electron microscope (SEM), a transmission electron microscope (TEM), or computed tomography (CT).

In addition, examples of the three-dimensional image data include captured data created by laminating tomographic images captured by computed tomography (CT) and model data created by computer-aided design (CAD) or the like.

In addition, examples of the waveform data include time-series data and displacement data. Examples of the time-series data include acoustic data, vibration data, and trends of stock price, but any data in which a numerical value changes with a change in time can be used as the time-series data. Examples of the displacement data include a surface height of a sample and a surface profile, but any data in which a numerical value changes with a change in coordinates and other parameters can be used as the displacement data.

In addition, examples of the other data include a cyclic voltammogram and a gas chromatography (GC) chart graph.

Further, as the analysis target data, for example, coordinate data such as a crystallographic information (CIF) file and numerical data such as a component table of a composition can also be used.

The user terminal 200 is a terminal operated by the user and is a computer device having a display device. The user terminal 200 transmits the analysis target data to the server 100 via the network N. Then, the user terminal 200 receives the analysis result of the analysis target data from the server 100 via the network N.

The server 100 receives the analysis target data from the user terminal 200 and analyzes the received analysis target data. Then, the server 100 transmits the analysis result to the user terminal 200 via the network N.

FIG. 2 is a block diagram showing a hardware configuration of the server according to Embodiment 1. As shown in FIG. 2, the server 100 includes a processor 110, a memory 120, a storage device 130, an input/output interface 140, a network interface 150, and an internal bus 160.

The internal bus 160 is a data transmission path for the processor 110, the memory 120, the storage device 130, the input/output interface 140, and the network interface 150 to transmit and receive data to and from each other. However, a method of connecting the processor 110 and the like to each other is not limited to the bus connection.

The memory 120 is a main storage device implemented by using a random access memory (RAM) or the like.

The storage device 130 is an auxiliary storage device implemented by using a hard disk, a solid state drive (SSD), a memory card, a read only memory (ROM), or the like. The storage device 130 stores a program for implementing a desired function.

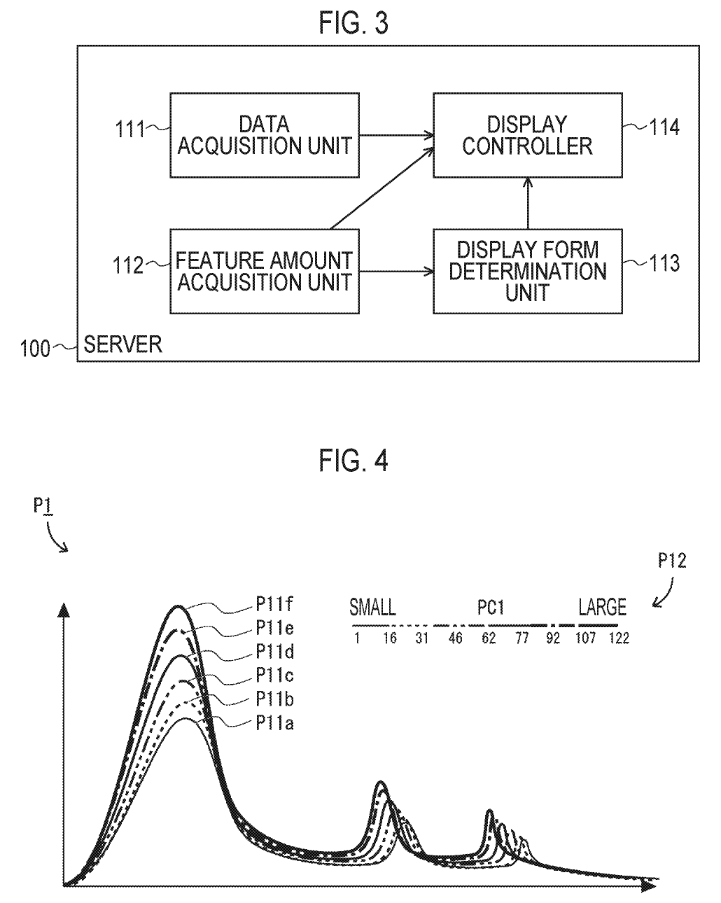

The processor 110 is various processors such as a central processing unit (CPU), a graphics processing unit (GPU), and a field-programmable gate array (FPGA). The processor 110 executes a function as each of functional blocks shown in FIG. 3, which will be described later, by reading out and executing the program stored in the storage device 130 into the memory 120.

The input/output interface 140 is an interface for connecting the server 100 and an input/output device. For example, an input device such as a keyboard or an output device such as a display device may be connected to the input/output interface 140.

The network interface 150 is an interface for connecting the server 100 to the network.

The program includes an instruction set (or a software code) that causes the computer to perform one or more functions described in the embodiment in a case where the program is read into the computer. The program may be stored in a non-transitory computer-readable medium or a tangible storage medium. Examples of the computer-readable medium or the tangible storage medium include a RAM, a ROM, a flash memory, an SSD, or other memory technologies, a CD-ROM, a digital versatile disc (DVD), a Blu-ray (registered trademark) disc, or other optical disc storages, a magnetic cassette, a magnetic tape, a magnetic disk storage, or other magnetic storage devices, but not limited thereto. The program may be transmitted on a transitory computer-readable medium or a communication medium. Examples of the transitory computer-readable medium or the communication medium include electrical, optical, acoustic, or other forms of propagating signals, but not limited thereto.

FIG. 3 is a block diagram showing functions of the server according to Embodiment 1. As shown in FIG. 3, the server 100 includes a data acquisition unit 111, a feature amount acquisition unit 112, a display form determination unit 113, and a display controller 114 as functional blocks.

The data acquisition unit 111 acquires the plurality of pieces of analysis target data. More specifically, the data acquisition unit 111 acquires the plurality of pieces of analysis target data from the user terminal 200 via the network N. Then, the data acquisition unit 111 outputs the acquired plurality of pieces of analysis target data to the display controller 114.

The data acquisition unit 111 does not need to acquire the pieces of analysis target data by receiving at once. For example, the data acquisition unit 111 may acquire the pieces of analysis target data by acquiring the analysis target data a plurality of times. In this case, the data acquisition unit 111 may store the acquired analysis target data in the storage device 130 each time the analysis target data is acquired. Then, in a case of displaying the analysis target data, the analysis target data to be displayed may be read out from the storage device 130 and output to the display controller 114.

In addition, the data acquisition unit 111 does not need to read out all of the analysis target data stored in the storage device 130. Only the analysis target data designated by the user may be read out and output to the display controller 114. That is, the data acquisition unit 111 may create a database in which the analysis target data is stored. Then, the data acquisition unit 111 according to the present embodiment may be configured such that the user can appropriately select the data to be displayed from the created database.

The feature amount acquisition unit 112 acquires the feature amount of the analysis target data. The feature amount acquisition unit 112 outputs the acquired feature amount to the display form determination unit 113 and the display controller 114.

The feature amount acquisition unit 112 may acquire the analysis target data from the data acquisition unit 111, for example. Then, the feature amount of the analysis target data may be acquired by extracting the feature amount from the acquired analysis target data. In addition, the feature amount acquisition unit 112 may acquire the feature amount recorded in association with the analysis target data from, for example, the database.

For example, the feature amount acquisition unit 112 may execute a principal component analysis (PCA) on the pieces of analysis target data to acquire a principal component as the feature amount. The principal component and the principal component score obtained by the principal component analysis are particularly difficult for the user to intuitively understand among the results obtained by the analysis using the feature amount. Therefore, the display system according to the present disclosure has a particularly

significant effect in a case where the principal component score is used as the feature amount. The feature amount acquisition unit 112 may acquire, as the feature amount, for example, a peak intensity, a wavelength, or meta-information (for example, a physical property value, a process variable, a composition ratio, and the like) associated with each piece of analysis data, in addition to the principal component score.

In addition, the feature amount acquisition unit 112 may combine, for example, two or more feature amounts selected by the user by a product or a sum, and output the combined value as the feature amount to the display form determination unit 113 and the display controller 114.

The display form determination unit 113 acquires the feature amounts of the pieces of analysis target data to be displayed from the feature amount acquisition unit 112. Then, the display form determination unit 113 determines, based on the order of the magnitudes of the feature amounts, the display form of the pieces of analysis target data to be plotted on one graph. The display form determination unit 113 outputs information on the determined display form to the display controller 114.

More specifically, the display form determination unit 113 determines, for example, the superimposition order of the pieces of analysis target data in one graph based on the order of the magnitudes of the feature amounts, as the display form. The display form determination unit 113 determines the superimposition order such that the analysis target data having a larger feature amount is displayed on a front surface side of the graph, for example. As a result, since the user can intuitively understand the fluctuation of the analysis target data with the change in the magnitude of the feature amount, the interpretation of the feature amount by the user is facilitated. The display form determination unit 113 may determine the superimposition order such that the analysis target data having a smaller feature amount is displayed on the front surface side of the graph.

Further, the display form determination unit 113 may determine, based on the contribution of the feature amount to the performance, the analysis target data to be displayed on the front surface side of the graph. For example, in a case where the performance is higher as the feature amount is smaller, the display form determination unit 113 determines the superimposition order such that the analysis target data having a smaller feature amount is displayed on the front surface side of the graph. On the other hand, in a case where the performance is higher as the feature amount is larger, the display form determination unit 113 determines the superimposition order such that the analysis target data having a larger feature amount is displayed on the front surface side of the graph. As a result, the user can easily identify the analysis target data having high performance, and the interpretation of the feature amount by the user is facilitated.

In addition, the display form determination unit 113 may determine an offset amount of the pieces of analysis target data in one graph based on the order of the magnitudes of the feature amounts, as the display form. More specifically, the display form determination unit 113 determines the offset amount such that the analysis target data having a larger value of the feature amount is shifted more upward from a reference position and the analysis target data having a smaller value of the feature amount is disposed at a position closer to the reference position, for example. As a result, the visibility of the analysis target data is improved, and the interpretation of the feature amount by the user is facilitated.

In addition, the display form determination unit 113 may change a thickness, a color, or a transparency of a plot line of each of the pieces of analysis target data in one graph based on the order of the magnitudes of the feature amounts, as the display form. As a result, the visibility of the analysis target data is further improved.

The display controller 114 acquires the analysis target data from the data acquisition unit 111, acquires the feature amount from the feature amount acquisition unit 112, and acquires information on the display form from the display form determination unit 113. The display controller 114 displays, based on the display form determined by the display form determination unit 113, the graph in which the pieces of analysis target data are plotted.

With reference to FIGS. 4 to 6, an example of a configuration of the display screen displayed on the user terminal 200 by the display controller 114 will be described. FIGS. 4 to 6 are schematic diagrams showing an example of a configuration of the display screen displayed on the user terminal by the display controller according to Embodiment 1.

First, an outline of FIGS. 4 to 6 will be described. As shown in FIGS. 4 to 6, six plot lines P11a, P11b, P11c, P11d, P11e, and P11f representing the analysis target data are displayed on the display screen P1 according to Embodiment 1. Unless otherwise specified, the six plot lines will be simply referred to as plot lines P11 hereinafter. In addition, the number of the plot lines P displayed on the display screen P1 is not limited to six, and any number of the plot lines are displayed. Further, the number of the displayed plot lines can be set to any number by the user. In the plot lines P11 shown in FIGS. 4 to 6, the plot line P11a has the smallest feature amount "PC1", and the feature amount "PC1" increases in the order of P11b, P11c, P11d, P11e, and P11f.

In addition, as shown in FIGS. 4 to 6, a scale display P12 indicating the magnitude of the value of the feature amount "PC1" is displayed on the display screen P1 according to Embodiment 1. The scale display P12 changes such that the value of the feature amount "PC1" increases from the left side to the right side. The user uses the scale display P12 to visually check which value of the feature amount corresponds to each of the plot lines P11a to P11f.

Subsequently, FIGS. 4 to 6 will be described in detail.

FIG. 4 is a schematic diagram showing an example of a configuration of the display screen in a case where the display form determination unit according to Embodiment 1 determines the superimposition order of the analysis target data as the display form. The display form determination unit 113 determines the superimposition order of the pieces of analysis target data in one graph based on the order of the magnitudes of the feature amounts, as the display form. Then, the display form determination unit 113 outputs information on the determined display form to the display controller 114. As shown in FIG. 4, the display controller 114 displays the plot lines P11 in the graph of the display screen P1 in the superimposition order of the pieces of analysis target data. As a result, since the user can intuitively understand the fluctuation of the analysis target data with the change in the magnitude of the feature amount, the interpretation of the feature amount is facilitated.

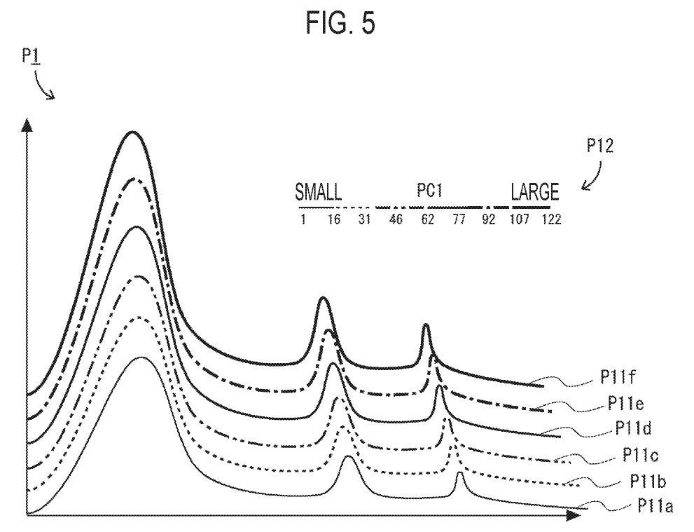

FIG. 5 is a schematic diagram showing an example of a configuration of the display screen in a case where the display form determination unit according to Embodiment 1 determines the offset amount of the analysis target data as the display form. The display form determination unit 113 determines the offset amount of the pieces of analysis target data in one graph based on the order of the magnitudes of the feature amounts, as the display form. Then, the display form determination unit 113 outputs information on the determined display form to the display controller 114. As shown in FIG. 5, the display controller 114 displays the plot lines P11 in the graph of the display screen P1 in accordance with the determined offset amount. As a result, the visibility of the analysis target data is improved, and the interpretation of the feature amount by the user is facilitated.

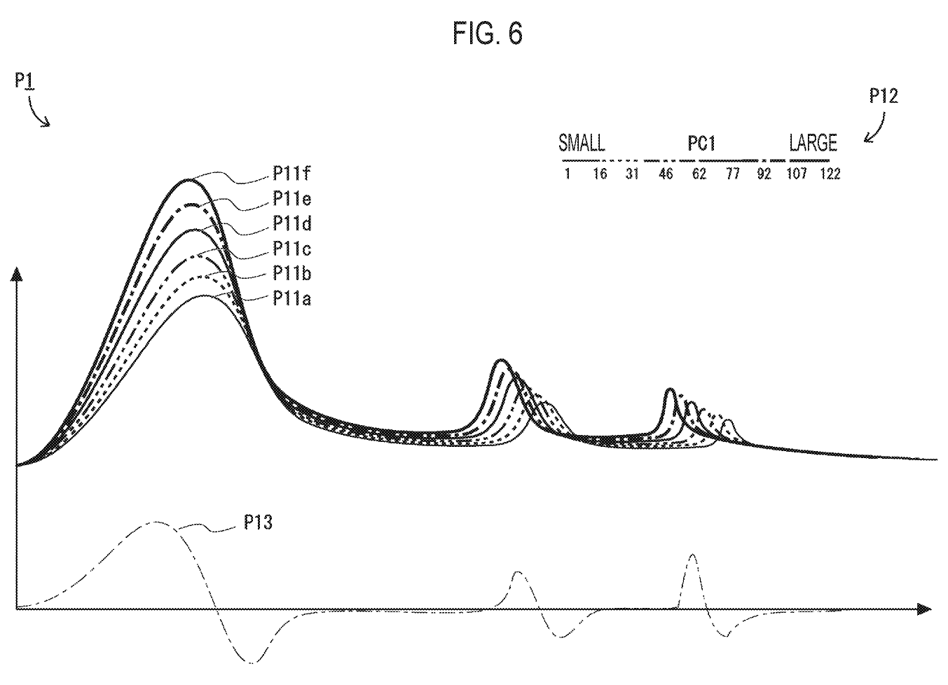

FIG. 6 is a schematic diagram showing another example of the configuration of the display screen in a case where the display form determination unit according to Embodiment 1determines the superimposition order of the analysis target data as the display form. The feature amount "PC1" in FIG. 6 is a principal component score acquired by executing the principal component analysis on the analysis target data. As shown in FIG. 6, the display controller 114 may further display, in the graph of the display screen P1, in addition to the plot lines P11, a plot line P13 representing the principal component of "PC1" that is the principal component score. As a result, the user can intuitively understand the relationship between the feature amount and the analysis target data, and the interpretation of the feature amount is facilitated.

### Operation of Display System

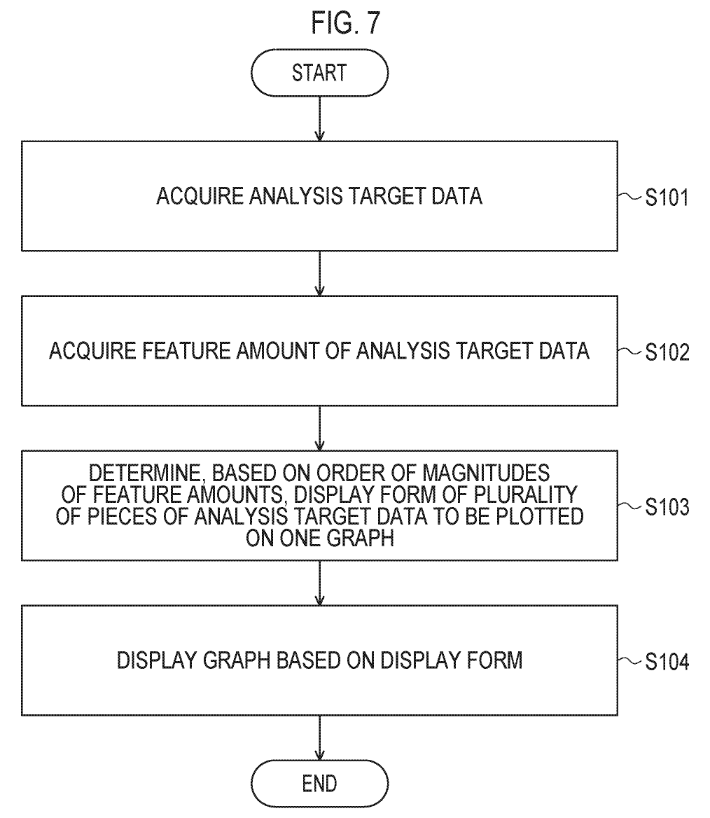

Subsequently, an operation of the display system, that is, a display method according to Embodiment 1 will be described. FIG. 7 is a flowchart showing the display method according to Embodiment 1.

In the processing procedure of FIG. 7, the processor 110 provided in the server 100 reads out and executes the program stored in the storage device 130 into the memory 120. As a result, the processor 110 functions as the data acquisition unit 111, the feature amount acquisition unit 112, the display form determination unit 113, and the display controller 114.

In the display method according to Embodiment 1, first, the processor 110 acquires the analysis target data (S101). That is, in S101, the processor 110 functions as the data acquisition unit 111.

Next, the processor 110 acquires the feature amount of the analysis target data (S102). That is, in S102, the processor 110 functions as the feature amount acquisition unit 112. More specifically, in S102, the processor 110 acquires the feature amount of the analysis target data to be displayed.

S102 may be a step of acquiring the feature amount by the processor 110 extracting the feature amount from the pieces of measurement data. In addition, S102 may be a step of acquiring the feature amount from the database stored in the storage device 130 or the like by the processor 110.

Next, the processor 110 determines, based on the order of the magnitudes of the feature amounts, the display form of the plurality of pieces of analysis target data to be plotted on one graph (S103). That is, in S103, the processor 110 functions as the display form determination unit 113. More specifically, in S103, the processor 110 determines, for example, the superimposition order of the pieces of analysis target data in one graph, the offset amount, the thickness of the plot line, the color of the plot line, the transparency of the plot line, or the like based on the order of the magnitudes of the feature amounts, as the display form.

Finally, the processor 110 displays, based on the display form determined in S103, the graph in which the pieces of analysis target data are plotted (S104), and the display system according to Embodiment 1 ends the series of operations. That is, in S104, the processor 110 functions as the display controller 114. More specifically, in S104, the processor 110 displays, based on the display form determined in S103, the graph in which the pieces of analysis target data are plotted.

As described above, the display system according to Embodiment 1 determines, based on the order of the magnitudes of the feature amounts of the plurality of pieces of analysis target data, the display form of the plurality of pieces of analysis target data to be plotted on one graph. With such a configuration, since the user can intuitively understand the fluctuation of the analysis target data with the change in the magnitude of the feature amount, the interpretation of the feature amount by the user is facilitated.

Although the present disclosure has been described in detail with reference to the embodiments, the present disclosure is not only limited to the configurations of the embodiments. It is needless to say that various modifications, corrections, and combinations that can be made by those skilled in the art within the scope of the claims of the present patent application are included.

What is claimed is:

1. A display system comprising:
a data acquisition unit configured to acquire a plurality of pieces of analysis target data;
a feature amount acquisition unit configured to acquire a feature amount of each of the pieces of analysis target data;
a display form determination unit configured to determine, based on an order of magnitudes of the feature amounts, a display form of the pieces of analysis target data to be plotted on one graph; and
a display controller configured to display the graph based on the display form.

2. The display system according to claim 1, wherein the display form determination unit is configured to determine a superimposition order of the analysis target data in the graph based on the order of the magnitudes of the feature amounts.

3. The display system according to claim 1, wherein the display form determination unit is configured to determine an offset amount of the analysis target data in the graph based on the order of the magnitudes of the feature amounts.

4. The display system according to claim 1, wherein:
the feature amount is a principal component score acquired by executing principal component analysis on the analysis target data; and
the display controller is configured to display a principal component on the graph.

5. A display method comprising:
acquiring a plurality of pieces of analysis target data;
acquiring a feature amount of each of the pieces of analysis target data;
determining, based on an order of magnitudes of the feature amounts, a display form of the pieces of analysis target data to be plotted on one graph; and
displaying the graph based on the display form.
